(19) United States
(12) Patent Application Publication
(10) Pub. No.: US 2011/0050949 A1
(43) Pub. Date: Mar. 3, 2011

(54) Color Adjusting Apparatus

(75) Inventor: Mitsuaki KUROKAWA, Toyonaka-shi (JP)

(73) Assignee: SANYO ELECTRIC CO., LTD., Osaka (JP)

(21) Appl. No.: 12/872,029

(22) Filed: Aug. 31, 2010

(30) Foreign Application Priority Data
Aug. 31, 2009 (JP) 2009-200032

(51) Int. Cl. H04N 9/73

(52) U.S. Cl. 348/223.1; 348/E09.051

(57) ABSTRACT

A color adjusting apparatus includes a first holder. A first holder holds a plurality of first color adjusting values respectively corresponding to a plurality of representative colors. An adjuster adjusts a color of an original image by referring to the plurality of first color adjusting values held by the first holder. An outputter outputs an image having the color adjusted by the adjuster, toward a display device. A first detector detects a color space adopted by the display device in association with the adjusting process of the adjuster. A first setter sets magnitudes of the plurality of first color adjusting values held by the first holder, to magnitudes corresponding to the color space detected by the first detector.

### CROSS REFERENCE OF RELATED APPLICATION

The disclosure of Japanese Patent Application No. 2009-200032, which was filed on Aug. 31, 2009, is incorporated herein by reference.

### BACKGROUND OF THE INVENTION

1. Field of the Invention

The present invention relates to a color adjusting apparatus. More particularly, the present invention relates to a color adjusting apparatus which is applied to a digital camera and adjusts a color of an object scene image.

2. Description of the Related Art

According to one example of this type of apparatus, a plurality of reference values respectively corresponding to a plurality of representative colors are held on a reference value table, and a plurality of target values respectively corresponding to the plurality of representative colors are held on a setting change-use table. Image data of a photographed object scene is subjected to a color adjustment based on the reference values held on the reference value table and the target values held on the setting change-use table. An image based on the image data on which the color adjustment is performed is displayed on a monitor in a real time. When a dial key is operated, a target value of a desired representative color held on the setting change-use table is changed. Therefore, a color tone of the real time image displayed on the monitor is also changed in response to the operation of the dial key.

However, in order to change the color tone of the image displayed on the monitor, it is necessary to adjust the target values one by one, and thus, there is a problem in operability. Furthermore, in a case of attempting to change the color tone so as to adapt to a color space adopted by the monitor, the above-described device requires an operator to have a knowledge regarding the color space, and thus, there is a problem in operability.

### SUMMARY OF THE INVENTION

A color adjusting apparatus according to the present invention, comprises: a first holder which holds a plurality of first color adjusting values respectively corresponding to a plurality of representative colors; an adjuster which adjusts a color of an original image by referring to the plurality of first color adjusting values held by the first holder; an outputter which outputs an image having the color adjusted by the adjuster, toward a display device; a first detector which detects a color space adopted by the display device in association with the adjusting process of the adjuster; and a first setter which sets magnitudes of the plurality of first color adjusting values held by the first holder, to magnitudes corresponding to the color space detected by the first detector.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing one embodiment of the present invention;

FIG. 3 is a block diagram showing one example of a configuration of a signal processing circuit applied to the embodiment in FIG. 2;

FIG. 4 is an illustrative view showing one example of a two-dimensionally expressed color space;

FIG. 5 is an illustrative view showing one example of a three-dimensionally expressed color space;

FIG. 6 is a flowchart showing one portion of behavior of a CPU applied to the embodiment in FIG. 2;

FIG. 7 is a flowchart showing another portion of the behavior of the CPU applied to the embodiment in FIG. 2;

FIG. 8(A) is an illustrative view showing one example of color adjusting behavior in which an sRGB color space and an adobe ROB color space are taken into consideration;

FIG. 8(B) is an illustrative view showing another example of the color adjusting behavior in which the sRGB color space and the adobe RGB color space are taken into consideration;

FIG. 9(A) is an illustrative view showing one example of color adjusting behavior in which the sRGB color space and an xvYCC color space are taken into consideration;

FIG. 9(B) is an illustrative view showing another example of the color adjusting behavior in which the sRGB color space and the xvYCC color space are taken into consideration;

FIG. 10 is a block diagram showing one example of a configuration of a color adjusting circuit applied to the embodiment in FIG. 2;

FIG. 11(A) is an illustrative view showing one example of a reference value table;

FIG. 11(B) is an illustrative view showing one example of a target value table;

FIG. 12 is a color distribution chart showing one example of a state where reference values and target values are placed;

FIG. 13 is a luminance distribution chart showing one example of a state where the reference values and the target values are placed;

FIG. 14 is a flowchart showing one portion of behavior of a region determining circuit;

FIG. 15 is an illustrative view showing one example of hue adjusting behavior;

FIG. 16 is an illustrative view showing one example of color-saturation adjusting behavior;

FIG. 17 is an illustrative view showing one example of lightness adjusting behavior;

FIG. 18 is a flowchart showing still another portion of the behavior of the CPU applied to the embodiment in FIG. 2; and

FIG. 19 is a flowchart showing yet another portion of the behavior of the CPU applied to the embodiment in FIG. 2.

### DETAILED DESCRIPTION OF THE PREFERRED EMBODIMENTS

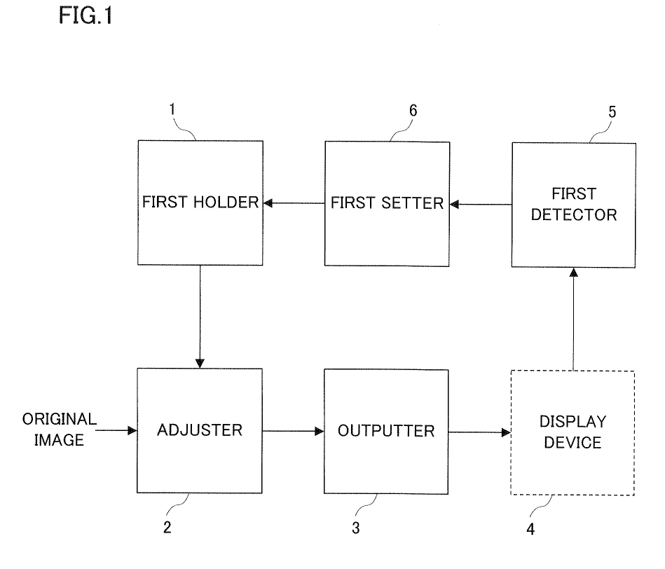

With reference to FIG. 1, a color adjusting apparatus of one embodiment of the present invention is basically configured as follows: A first holder 1 holds a plurality of first color adjusting values respectively corresponding to a plurality of representative colors. An adjuster 2 adjusts a color of an original image by referring to the plurality of first color adjusting values held by the first holder 1. An outputter 3 outputs an image having the color adjusted by the adjuster 2, toward a display device 4. A first detector 5 detects a color space adopted by the display device 4 in association with the adjusting process of the adjuster 2. A first setter 6 sets magnitudes of the plurality of first color adjusting values held by the first holder 1, to magnitudes corresponding to the color space detected by the first detector 5.

Thus, the color space adopted by the display device 4 is detected by the first detector 5, and the magnitudes of the plurality of first color adjusting values are set to the magnitudes corresponding to the detected color space. This enables operability improvement achieved when the setting is changed so as to adapt to the color space adopted by the display device 4.

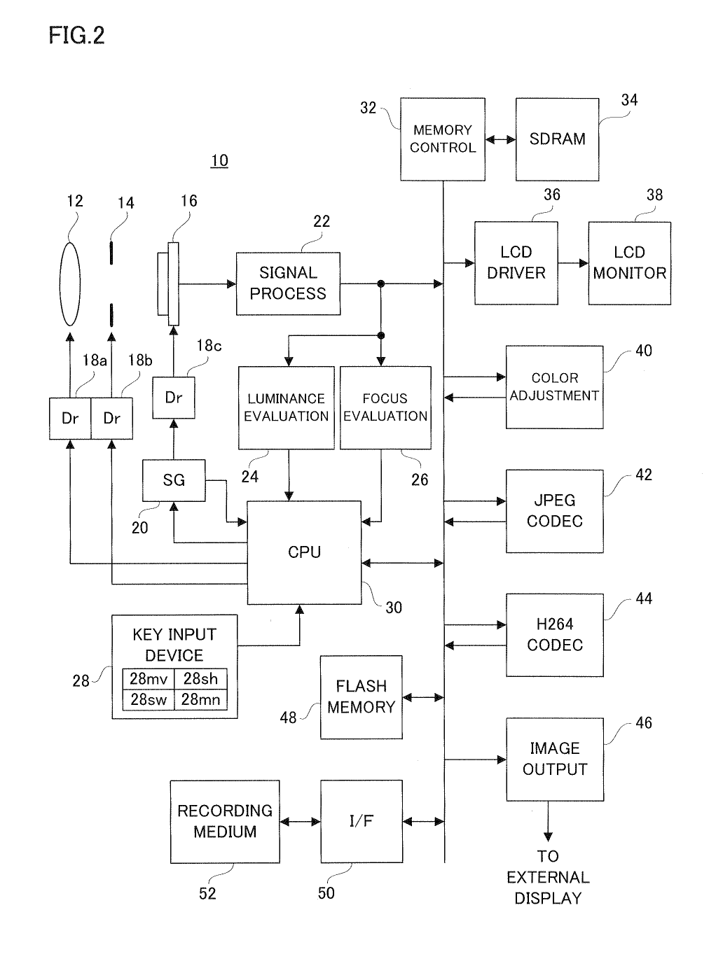

With reference to FIG. 2, a digital camera 10 according to this embodiment includes a focus lens 12 and an aperture mechanism 14 respectively driven by drivers 18a and 18b. An optical image of an object scene that undergoes the focus lens 12 and the aperture mechanism 14 enters, with irradiation, an imaging surface of an imaging device 16, and is subjected to photoelectric conversion. Thereby, electric charges representing an object scene image are produced. The imaging surface is covered with a color filter having a Bayer array of primary colors (not shown), and electric charges produced in each of a plurality of pixels arranged on the imaging surface have any one of color information, i.e., Red (R), Green (G), and Blue (B).

When a camera mode is selected by a mode selector button 28sw arranged on a key input device 28, a CPU 30 commands a driver 18c to repeatedly perform pre-exposure behavior and electric-charge reading-out behavior in order to execute a through-image process. In response to a vertical synchronization signal Vsync cyclically generated from a Signal Generator (SG) 20, the driver 18c performs the pre-exposure on the imaging surface and also reads out the electric charges produced on the imaging surface in a raster-scanning manner. From the imaging device 16, raw image data based on the read-out electric charges are cyclically outputted.

A signal processing circuit 22 performs processes, such as color separation, white balance adjustment, γ correction, YUV conversion, and zoom operation, on the raw image data outputted from the imaging device 16, and writes the image data created thereby into an SDRAM 34 through a memory control circuit 32. An LCD driver 36 repeatedly reads out the image data written into the SDRAM 34 through the memory control circuit 32, and drives an LCD monitor 38 based on the read-out image data. As a result, a real-time moving image (through image) of the object scene is displayed on a monitor screen.

A luminance evaluating circuit 24 defines, as an AE area, a whole evaluation area (not shown) allocated to the imaging surface, and integrates Y data belonging to the AE area, out of Y data outputted from the signal processing circuit 22 at each generation of the vertical synchronization signal Vsync. An integral value obtained thereby is repeatedly outputted, as an AE evaluation value, from the luminance evaluating circuit 24.

The CPU 30 repeatedly executes a through image-use AE process (simple AE process) in parallel with the above-described through-image process, in order to calculate an appropriate EV value based on the AE evaluation value outputted from the luminance evaluating circuit 24. An aperture amount and an exposure time period that define the calculated appropriate EV value are set to the drivers 18b and 18c, respectively. As a result, a brightness of the through image displayed on the LCD monitor 38 is moderately adjusted.

Under the camera mode, a still image mode for recording a still image and a moving image mode for recording a moving image are prepared. Mode switching between the still image mode and the moving image mode is executed by operating the mode selector button 28w.

When a shutter button 28sh on the key input device 28 is half-depressed in a state where the still image mode is selected, a strict recording-use AE process is executed in order to calculate an optimal EV value based on the AE evaluation value outputted from the luminance evaluating circuit 24. Similarly to the above-described case, an aperture amount and an exposure time period that define the calculated optimal EV value are set to the drivers 18b and 18c, respectively. As a result, the brightness of the through image displayed on the LCD monitor 38 is strictly adjusted.

Upon completion of the recording-use AE process, an AF process based on output of a focus evaluating circuit 26 is executed. The focus evaluating circuit 26 defines one portion of the evaluation area as an AF area, and integrates a high-frequency component of Y data belonging to the AF area, out of the Y data outputted from the signal processing circuit 22 in response to the vertical synchronization signal Vsync. The integral value obtained thereby is repeatedly outputted, as an AF evaluation value, from the focus evaluating circuit 26.

The CPU 30 fetches the AF evaluation values thus outputted from the focus evaluating circuit 26, and searches a position corresponding to a focal point by a so-called hill-climbing process. After moving stepwise in an optical axis direction at each generation of the vertical synchronization signal Vsync, the focus lens 12 is placed at the position corresponding to the focal point.

When the shutter button 28sh is fully depressed after being half-depressed, the CPU 30 changes a setting of the signal processing circuit 22 and commands a JPEG codec 42 and an I/F 50 to execute a still-image recording process.

The signal processing circuit 22 creates image data that complies with the changed setting, and writes the created image data into the SDRAM 34 through the memory control circuit 32. The JPEG codec 42 reads out the image data thus secured in the SDRAM 34 through the memory control circuit 32, compresses the read-out image data in a JPEG format, and writes the compressed image data, i.e., JPEG data, into the SDRAM 34 through the memory control circuit 32. The I/F 50 reads out the JPEG data accommodated in the SDRAM 34 through the memory control circuit 32, and records a still image file including the read-out JPEG data onto a recording medium 52.

The setting of the signal processing circuit 22 is restored to an original state at a time point at which one frame of the image data to be recorded is written into the SDRAM 34. Thereby, the through-image process is resumed.

When a movie button 28mv arranged on the key input device 28 is operated in a state where the moving image mode is selected, the CPU 30 changes the setting of the signal processing circuit 20, and commands an H264 codec 44 and an IT 50 to start a moving-image recording process.

The signal processing circuit 22 creates image data that complies with the changed setting, and writes the created image data into the SDRAM 34 through the memory control circuit 32. The H264 codec 44 repeatedly reads out the image data accommodated in the SDRAM 34 through the memory control circuit 32, repeatedly compresses the read-out image data in an H264 format, and repeatedly writes the compressed image data, i.e., H264 data, into the SDRAM 34 through the memory control circuit 32. The I/F 50 reads out the H264 data accommodated in the SDRAM 34 from the SDRAM 34 through the memory control circuit 32, and records a moving image file including the read-out H264 data onto the recording medium 52.

When the movie button 28mv is operated again, the CPU 30 restores the setting of the signal processing circuit 22 to the original state, and commands the H264 codec 44 and the I/F 50 to end the moving-image recording process. The H264 codec 44 ends reading out of the image data from the SDRAM 34. Also the I/F 50 ends reading out of the H264 data from the SDRAM 34, and closes the moving image file of a recording destination.

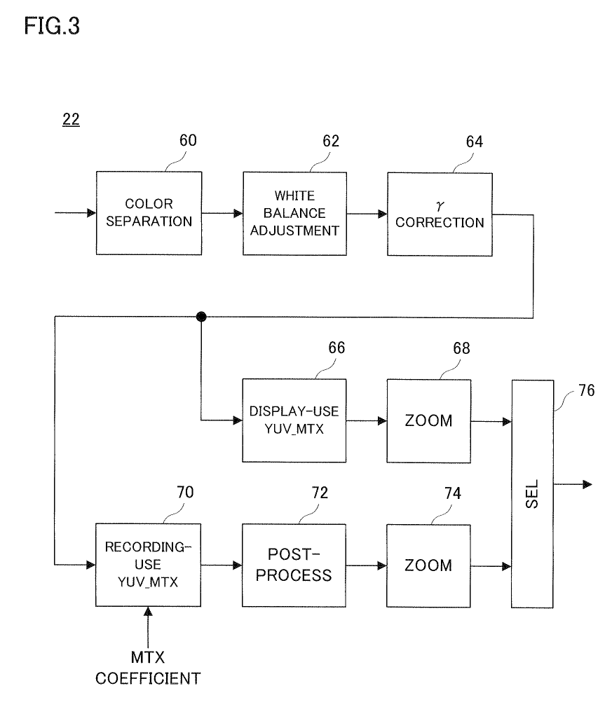

The signal processing circuit 22 is configured as shown in FIG. 3. The raw image data outputted from the imaging device 16 is subjected to a color separation process by a color separating circuit 60. Thereby, RGB-formatted image data each of which pixels has all the color information, R, G, and B is created. The created RGB-formatted image data undergoes a white balance adjusting process by a white-balance adjusting circuit 62 and a γ-correcting process by a γ correcting circuit 64, and is applied to a display-use YUV matrix arithmetic circuit 66 and a recording-use YUV matrix arithmetic circuit 70.

The display-use YUV matrix arithmetic circuit 66 executes a matrix arithmetic operation in which a matrix coefficient corresponding to the color space adopted by the LCD monitor 38 (=sRGB color space) is referred to so as to convert the RGB-formatted image data into YUV-formatted image data. The converted image data is applied to a zoom circuit 68 and subjected to a shrinking zoom corresponding to a resolution of the LCD monitor 38.

To the recording-use YUV matrix arithmetic circuit 70, the matrix coefficient corresponding to the sRGB color space, an adobe RGB color space, or an xvYCC color space is set.

More specifically, when a menu display button 28 nm is operated in a state where the still image mode is selected, a menu having two items of “sRGB” and “adobe RGB” is displayed on the LCD monitor 38 by the LCD driver 36. Herein, if “sRGB” is selected, then the matrix coefficient corresponding to the sRGB color space is set. Furthermore, if “adobe RGB” is selected, then the matrix coefficient corresponding to the adobe RGB color space is set.

Moreover, when the menu display button 28 nm is operated in a state where the moving image mode is selected, a menu having two items of “sRGB” and “xvYCC” is displayed on the LCD monitor 38 by the LCD driver 36. Herein, if “sRGB” is selected, then the matrix coefficient corresponding to the sRGB color space is set. Furthermore, if “xvYCC” is selected, then the matrix coefficient corresponding to the xvYCC color space is set.

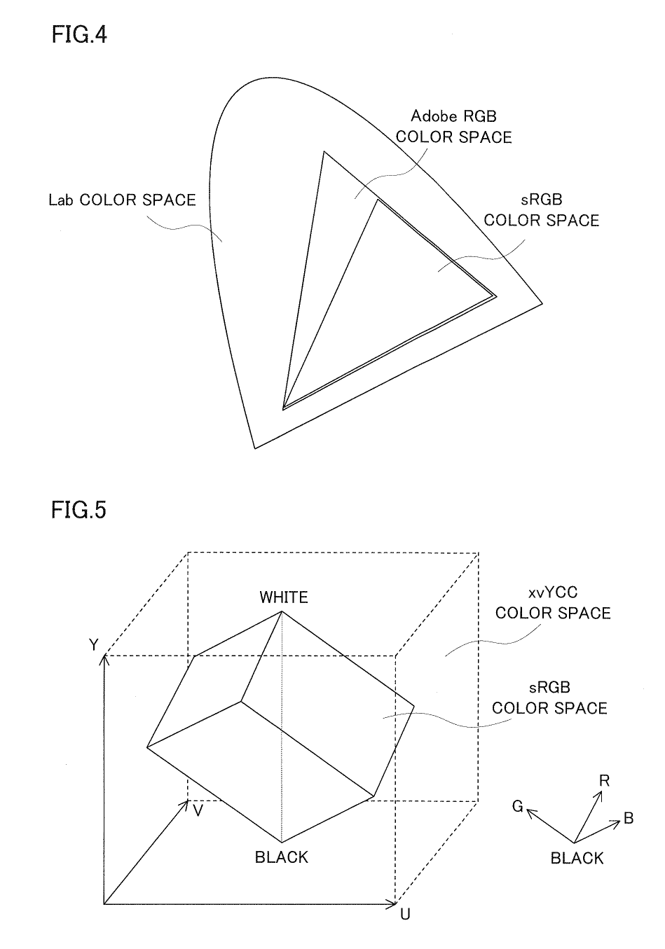

It is noted that in a Lab color space that is two-dimensionally expressed, the sRGB color space and the adobe RGB color space have expansion shown in FIG. 4. Moreover, in the xvYCC color space that is three-dimensionally expressed, the sRGB color space has expansion shown in FIG. 5. That is, the expansion of the color space is enlarged in the order of sRGB to adobe RGB to xvYCC.

Returning to FIG. 3, the recording-use YUV matrix arithmetic circuit 70 converts the RGB-formatted image data into the YUV formatted-image data by the matrix arithmetic operation in which the set matrix coefficient is referred to. The converted image data undergoes noise removal and edge emphasis in a post-processing circuit 72, is applied to a zoom circuit 74, and is zoomed with a zoom magnification corresponding to the still-image recording process or the moving-image recording process.

A selector 76 selects the zoom circuit 68 corresponding to the through-image process while selecting the zoom circuit 74 corresponding to the still-image recording process or the moving-image recording process. The thus-selected image data is outputted toward the memory control circuit 32.

It is noted that the setting changing process of the signal processing circuit 22 responding to the operation of the shutter button 28sh or the movie button 28mv is equivalent to a process for changing a selection destination of the selector 76 from the zoom circuit 68 to the zoom circuit 74. Moreover, a process for restoring the changed setting is equivalent to a process for changing the selection destination of the selector 76 from the zoom circuit 74 to the zoom circuit 68.

Furthermore, in a header of each of the still image file created by the still-image recording process and the moving image file created by the moving-image recording process, color space information for identifying the color space selected by the menu operation is described.

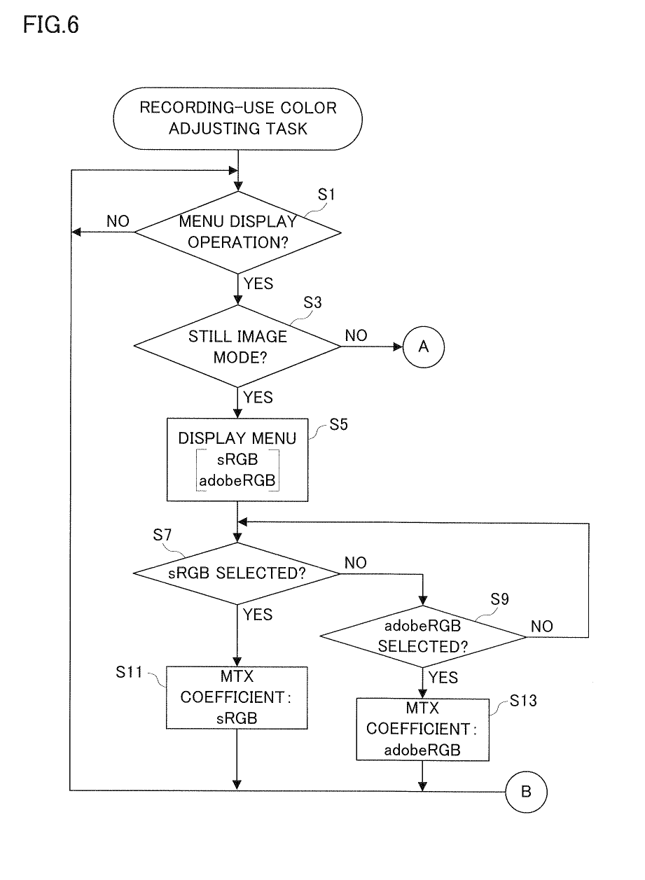

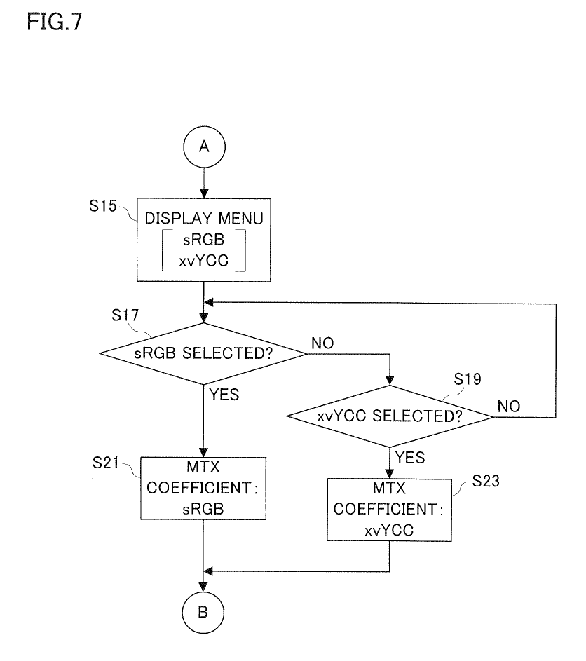

Upon controlling the matrix coefficient set to the recording-use YUV matrix arithmetic circuit 70, the CPU 30 executes a recording-use color adjusting task shown in FIG. 6 and FIG. 7 under the camera mode. It is noted that a control program corresponding to this task is stored in a flash memory 48.

In a step S1, it is determined whether or not the menu display button 28mn is operated. When a determined result is updated from NO to YES, it is determined in a step S3 whether or not an imaging mode selected at a current time point is the still image mode or the moving image mode. If the current imaging mode is the still image mode, then the process advances to a step S5 so as to display the menu having the two items of “sRGB” and “adobe RGB” on the LCD monitor 38.

In a step S7, it is determined whether or not “sRGB” is selected on the display menu. In a step S9, it is determined whether or not “adobe RGB” is selected on the display menu. When YES is determined in the step S7, the process advances to a step S11 so as to set the matrix coefficient corresponding to the sRGB color space to the recording-use YUV matrix arithmetic circuit 70. When YES is determined in the step S9, the process advances to a step S13 so as to set the matrix coefficient corresponding to the adobe RGB color space to the recording-use YUV matrix arithmetic circuit 70. Upon completion of the process in the step S11 or S13, the process returns to the step S1.

If the current imaging mode is the moving image mode, the process advances to a step S15 so as to display the menu having the two items of “sRGB” and “xvYCC” on the LCD monitor 38. In a step S17, it is determined whether or not “sRGB” is selected on the display menu. In a step S19, it is determined whether or not “xvYCC” is selected on the display menu. When YES is determined in the step S17, the process advances to a step S21 so as to set the matrix coefficient corresponding to the sRGB color space to the recording-use YUV matrix arithmetic circuit 70. When YES is determined in the step S19, the process advances to a step S23 so as to set the matrix coefficient corresponding to the xvYCC color space to the recording-use YUV matrix arithmetic circuit 70. Upon completion of the process in the step S21 or S23, the process returns to the step S1.

When a reproduction mode is selected by the mode selector button 28m and the still image file is selected, the CPU 30 commands the I/F 50 and the JPEG codec 42 to perform the still-image reproducing process.

The I/F 50 reads out the JPEG data of the selected still image file from the recording medium 52, and writes the read-out JPEG data into the SDRAM 34 through the memory control circuit 32. The JPEG codec 42 reads out the JPEG data accommodated in the SDRAM 34 through the memory control circuit 32, decompresses the read-out JPEG data in the JPEG format, and writes the decompressed image data into the SDRAM 34 through the memory control circuit 32.

On the other hand, when the moving image file is selected in the reproduction mode, the CPU 30 commands the I/F 50 and the H264 codec 44 to perform the moving-image reproducing process. The I/F 50 reads out the H264 data in the selected moving image file from the recording medium 52, and writes the read-out H264 data into the SDRAM 34 through the memory control circuit 32. The H264 codec 44 reads out the H264 data accommodated in the SDRAM 34 through the memory control circuit 32, decompresses the read-out H264 data in the H264 format, and writes the decompressed image data into the SDRAM 34 through the memory control circuit 32.

In association with such a still-image reproducing process or moving-image reproducing process, the CPU 30 issues a display command to the LCD driver 36 or an image output circuit 46. The display command is issued toward the LCD driver 36 when the LCD monitor 38 is selected as the display device, while the display command is issued toward the image output circuit 46 when an external display is selected as the display device.

In a case where the LCD monitor 38 is selected as the display device, the LCD driver 36 reads out the image data accommodated in the SDRAM 34 through the memory control circuit 32, and drives the LCD monitor 38 based on the read-out image data. As a result, the desired still image or moving image is displayed on the LCD monitor 38.

In a case where the external display is selected as the display device, the image output circuit 46 reads out the image data accommodated in the SDRAM 34 through the memory control circuit 32, and outputs the read-out image data toward the external display. As a result, the desired still image or moving image is displayed on the external display.

The color space adopted by the LCD monitor 38 is fixed (=sRGB) while the color space adopted by the external display is floated. Moreover, the color space adopted by the image data contained in the still image file or the moving image file can fluctuate among the sRGB color space, the adobe RGB color space, and the xvYCC color space. In consideration of such a case, when the color space adopted by the image data to be reproduced differs from the color space adopted by the display device, the CPU 30 adjusts the color of the image data accommodated in the SDRAM 34 by utilizing a color adjusting circuit 40.

More specifically, the CPU 30 sets reference values that indicate magnitudes corresponding to the color space adopted by the image data to be reproduced, to a reference value table TBLref (described later) of the color adjusting circuit 40, and sets target values that indicate magnitudes corresponding to the color space adopted by the display device, to a target value table TBLtrgt (described later) of the color adjusting circuit 40.

Furthermore, in order to prohibit a fluctuation of a hue (i.e., in order to save the hue), the CPU 30 matches target H component values defining the target values set to the target value table TBLtrgt to reference H component values defining the reference values set to the reference value table TBLref.

Upon completion of setting the reference values and the target values in this way, the CPU 30 starts up the color adjusting circuit 40. The color adjusting circuit 40 reads out the image data to be reproduced, from the SDRAM 34 through the memory control circuit 32, adjusts the color of the read-out image data by referring to the reference value table TBLref and the target value table TBLtrgt, and writes the image data having the adjusted color into the SDRAM 34 through the memory control circuit 32.

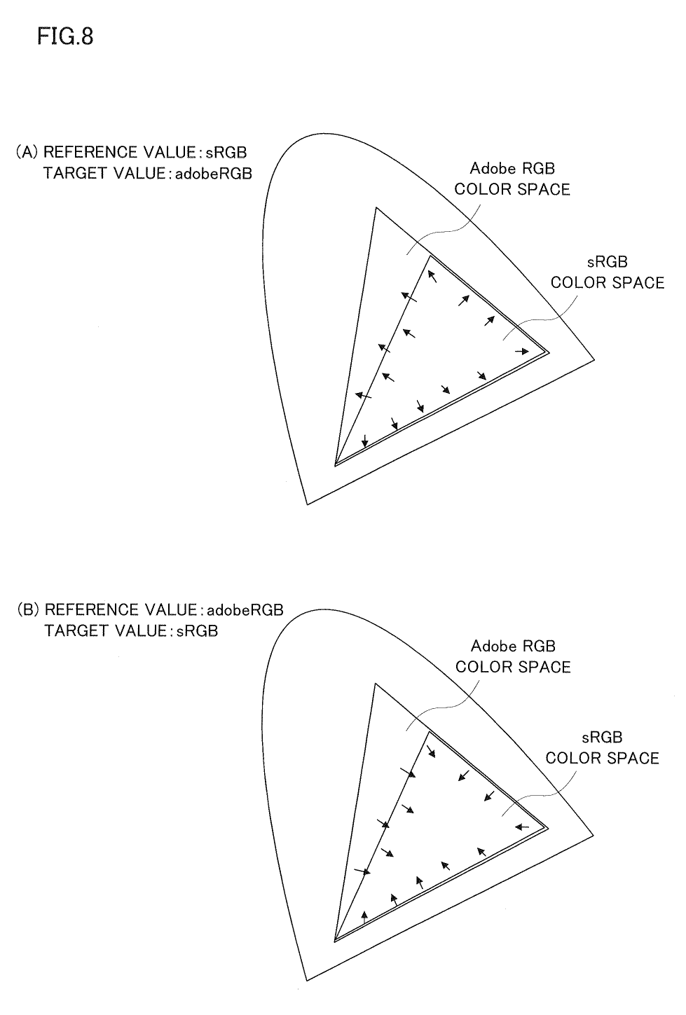

For example, in a case where the color space adopted by the image data to be reproduced is the sRGB color space and the color space adopted by the display device is the adobe RGB color space, the color adjusting behavior is executed as shown by an arrow in FIG. 8(A). Moreover, in a case where the color space adopted by the image data to be reproduced is the adobe RGB color space and the color space adopted by the display device is the sRGB color space, the color adjusting behavior is executed as shown by an arrow in FIG. 8(B).

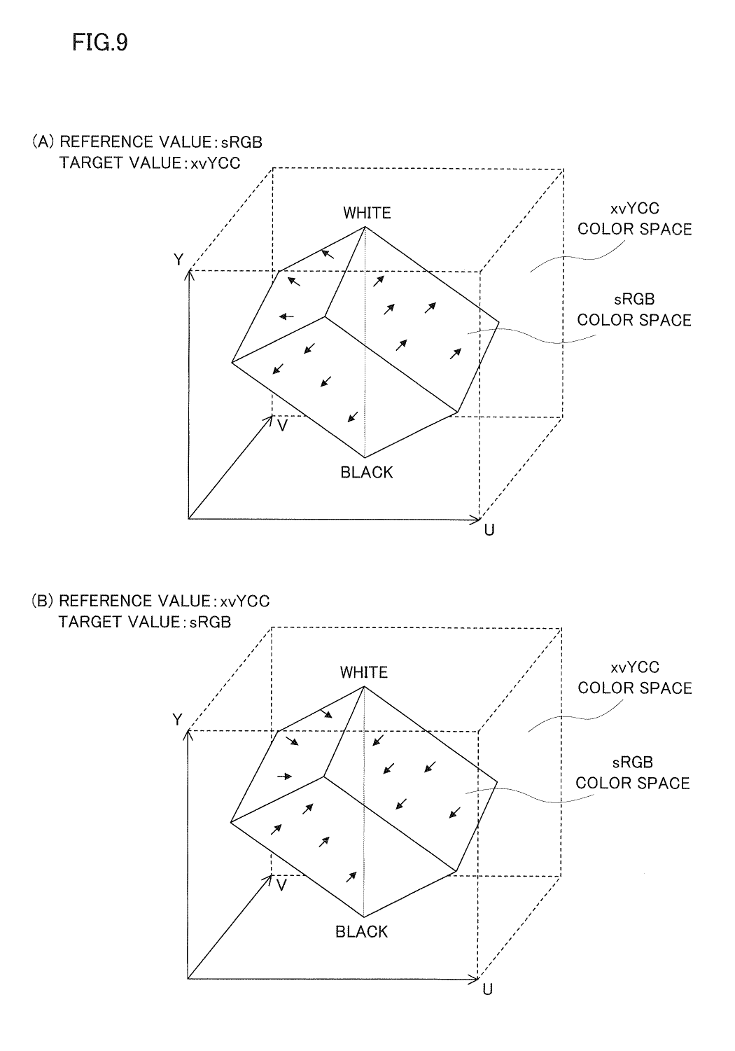

Furthermore, in a case where the color space adopted by the image data to be reproduced is the sRGB color space and the color space adopted by the display device is the xvYCC color space, the color adjusting behavior is executed as shown by an arrow in FIG. 9(A). Moreover, in a case where the color space adopted by the image data to be reproduced is the xvYCC color space and the color space adopted by the display device is the sRGB color space, the color adjusting behavior is executed as shown by an arrow in FIG. 9(B).

The LCD driver 36 or the image output circuit 46 that has received the display command executes the above-described display process on the image data on which the color adjustment is performed in this way. Thereby, a color reproducibility of the display image is improved.

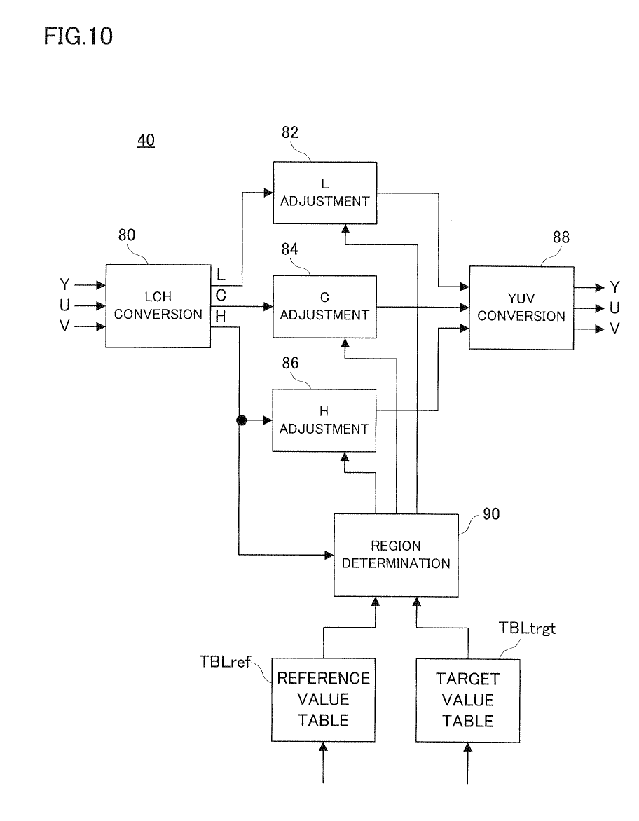

The color adjusting circuit 40 is configured as shown in FIG. 10. The YUV formatted-image data read out from the SDRAM 34 is converted into LCH-formatted image data by an LCH converting circuit 80. An L component (lightness component), a C component (color-saturation component), and an H component (hue component) forming the converted image data are applied to an L adjusting circuit 82, a C adjusting circuit 84, and an H adjusting circuit 86, respectively.

The L adjusting circuit 82, the C adjusting circuit 84, and the H adjusting circuit 86 respectively perform a predetermined arithmetic operation on the inputted L component, C component, and H component so as to create a corrected L component, a corrected C component, and a corrected H component. The created corrected H component, corrected C component, and corrected L component are thereafter applied to the YUV converting circuit 88. Thereby, the LCH-formatted image data is restored to the YUV formatted-image data.

The H component outputted from the LCH converting circuit 80 is also applied to a region determining circuit 90. By referring to the reference value table TBLref, the region determining circuit 90 determines a region to which the H component belongs, by each pixel. Furthermore, the region determining circuit 90 reads out two reference values corresponding to a determined result from the reference value table TBLref, and at the same time, reads out two target values corresponding to the determined result from the target value table TBLtrgt.

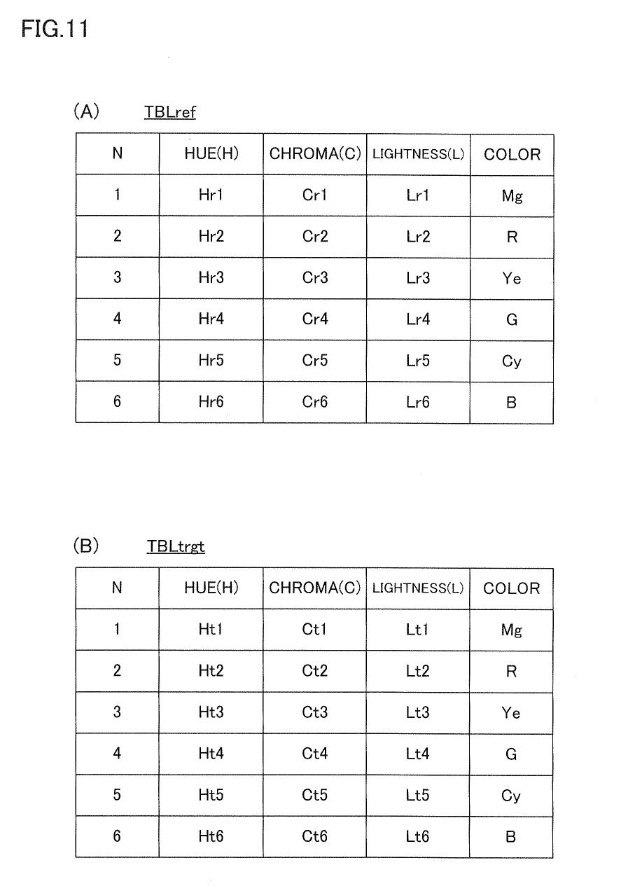

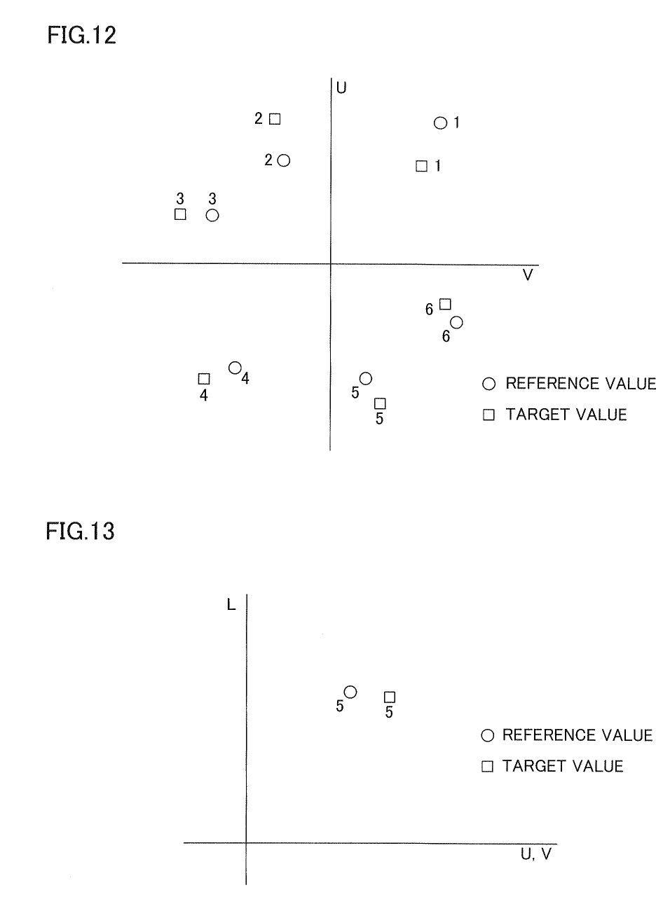

With reference to FIG. 11(A), the reference value table TBLref has six columns. In each column, a reference H component value Hr_*(*: 1˜6, hereinafter, the same applies), a reference C component value Cr_*, and a reference L component value Lr_* are described. The reference H component value Hr_*, the reference C component value Cr_*, and the reference L component value Lr_* described in the same column define one reference value, and a total of six reference values are held on the reference value table TBLref. Furthermore, these six reference values correspond to six representative colors of Magenta (Mg), Red (R), Yellow (Ye), Green (G), Cyan (Cy), and Blue (B), respectively, and are distributed in the YUV space as shown in FIG. 12 and FIG. 13. It is noted that only the reference value corresponding to Cy is shown in FIG. 13.

The target value table TBLtrgt is formed as shown in FIG. 11(B). Also the target value table TBLtrgt has six columns. In each column, a target H component value Hr_*, a target C component value Cr_*, and a target L component value Lr_* are described.

The target H component value Hr_*, the target C component value Cr_*, and the target L component value Lr_* described in the same column define one target value, and a total of six target values are held on the target value table TBLtrgt. Also these six target values correspond to six representative colors of Mg, R, Ye, G, Cy, and B, respectively, and are distributed in the YUV space as shown in FIG. 12 and FIG. 13. It is noted that only the target value corresponding to Cy is shown in FIG. 13.

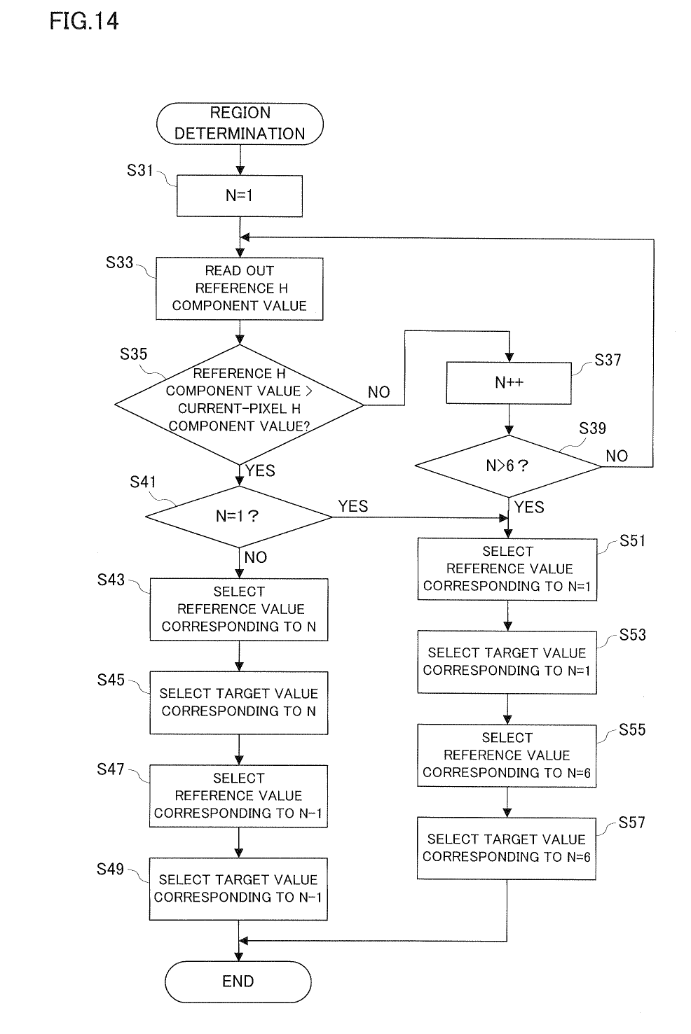

The region determining circuit 90 executes a process that follows a flowchart shown in FIG. 14 by noticing the H component value of each pixel applied from the LCH converting circuit 80.

Firstly, in a step S31, a variable N is set to “1”. In a step S33, the reference H component value Hr_N is reads out from the reference value table TBLref. In a step S35, the H component value of the noticed pixel (=current-pixel H component value) is compared with the reference H component value Hr_N read out in the step S33.

If the reference H component value Hr_N is larger than the current-pixel H component value, then YES is determined in the step S35. It is determined in a step S41 whether or not the variable N indicates “1”. On the other hand, if the reference H component value Hr_N is equal to or less than the current-pixel H component value, then the variable N is incremented in a step S37. In a step S39, it is determined whether or not the incremented variable N exceeds “6”. When NO is determined in the step S41, the process advances to a step S43. When YES is determined in the step S41 or S39, the process advances to a step S51. When NO is determined in the step S39, the process returns to the step S33.

In the step S43, the reference H component value Hr_N, the reference C component value Cr_N, and the reference L component value Lr_N are selected from the reference value table TBLref as “Hr_α”, “Cr_α”, and “Lr_α”. In a step S45, the target H component value Ht_N, the target C component value Ct_N, the target L component value Lt_N are selected from the target value table TBLtrgt as “Ht_α”, “Ct_α”, and “Lt_α”.

Moreover, in a step S47, the reference H component value Hr_N−1, the reference C component value Cr_N−1, and the reference L component value Lr_N−1 are selected from the reference value table TBLref as “Hr_β”, “Cr_β”, and “Lr_β”. In a step S49, the target H component value Ht_N−1, the target C component value Ct_N−1, and the target L component value Lt_N−1 are selected from the target value table TBLtrgt as “Ht_β”, “Ct_β”, and “Lt_β”.

On the other hand, in the step S51, the reference H component value Hr_{—}1, the reference C component value Cr_{—}1, and the reference L component value Lr_{—}1 are selected from the reference value table TBLref as “Hr_α”, “Cr_α”, and “Lr_α”. In a step S53, the target H component value Ht_{—}1, the target C component value Ct_{—}1, and the target L component value Lt_{—}1 are selected from the target value table TBLtrgt as “Ht_α”, “Ct_α” and “Lt_α”.

Furthermore, in a step S55, the reference H component value Hr_{—}6, the reference C component value Cr_{—}6, and the reference L component value Lr_{—}6 are selected from the reference value table TBLref as “Hr_β”, “Cr_β”, and “Lr_β”. In a step S57, the target H component value Ht_{—}6, the target C component value Ct_{—}6, and the target L component value Lt_{—}6 are selected from the target value table TBLtrgt as “Ht_β”, “Ct_β”, and “Lt_β”.

Thus, the two reference values respectively having the two reference H component values which sandwich the H component value of the noticed pixel, and the two target values corresponding to the two reference values are detected.

The reference H component values Hr_α and Hr_β, and the target H component values Ht_α and Ht_β are applied to the H adjusting circuit 86. Furthermore, the reference C component values Cr_α and Cr_β, and the target C component values Ct_α and Ct_β are applied to the C adjusting circuit 84. Moreover, the reference L component values Lr_α and Lr_β, and the target L component values Lt_α and Lt_β are applied to the L adjusting circuit 82.

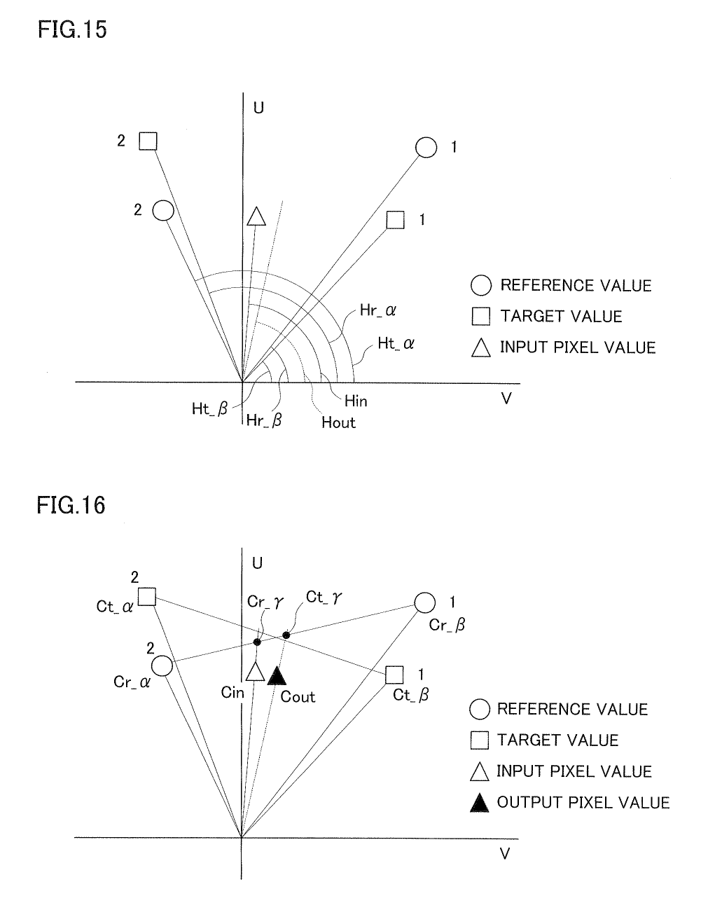

The H adjusting circuit 86 converts the H component value of the noticed pixel (=current−pixel H component value) Hin applied from the LCH converting circuit 80 into a corrected H component value Hout according to Equation 1. The corrected H component value Hout has a magnitude indicated by a dote line in FIG. 15.

Hout=(Ht_{—}α×θ2+Ht_{—}β×θ1)/(θ1+θ2)

θ1=|Hr_{—}α−Hin|

θ2=|Hr_{—}β−Hin| [Equation 1]

Moreover, the H adjusting circuit 22f outputs angle data θ1 and θ2 to the C adjusting circuit 84 and the L adjusting circuit 82, and at the same time, outputs angle data θ3(=|Ht_α−Hout|) and θ4(=|Ht_β−Hout|) to the L adjusting circuit 82.

The C adjusting circuit 84 converts the C component value of the noticed pixel (=current−pixel C component value) Cin applied from the LCH converting circuit 80 into a corrected C component value Cout according to Equation 2. The corrected C component value has a magnitude shown in FIG. 16.

Cout=Cin·{Ct_β+(Ct_{—}α−Ct_β)×θ2/(θ1+θ2)}/{Cr_β+(Cr_{—}α−Cr_β)×θ2/(θ1+θ2)} [Equation 2]

Furthermore, according to Equation 3, a C adjusting circuit 22e calculates a C component value Cr_γ at intersection coordinates between a straight line linking CH-system coordinates (0,0) and (Cin, Hin) and a straight line linking coordinates (Cr_β, Hr_β) and (Cr_α, Hr_α), and a C component value Ct_γ at intersection coordinates between a straight line linking CH-system coordinates (0, 0) and (Cout, Hout) and a straight line linking coordinates (Ct_β, Ht_β) and (Ct_α, Ht_α). Then, the calculated C component values Cr_γ and Ct_γ, together with the above-described current pixel C component value Cin and corrected C component value Cout, are outputted to the L adjusting circuit 82.

Cr_{—}γ=Cr_β+(Cr_{—}α−Cr_β)×θ2/(θ1+θ2)

Ct_{—}γ=Ct_β+(Ct_{—}α−Ct_β)×θ4/(θ3+θ4) [Equation 3]

The L adjusting circuit 22d converts the L component value of the noticed pixel (=current−pixel L component value) Lin applied from the LCH converting circuit 22c into a corrected L component value Lout according to Equation 4. The corrected L component value Lout has a magnitude shown in FIG. 11.

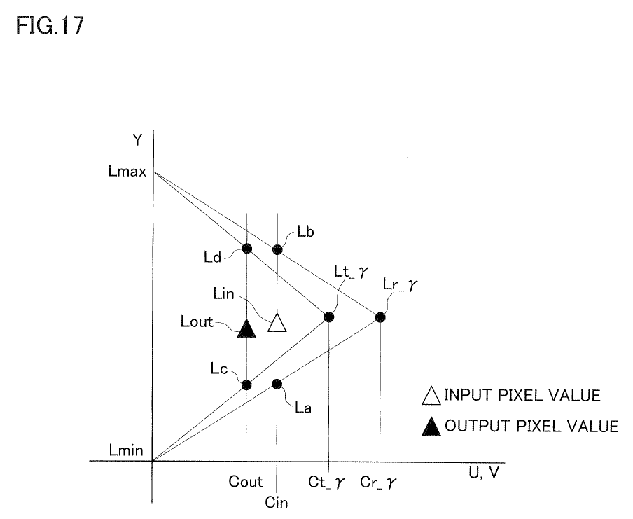

With reference to FIG. 17, Lmax and Lmin are equivalent to a maximum value and a minimum value of α reproducible lightness, respectively. The L component value, the C component value, and the H component value of the noticed pixel exist on a surface formed by LCH-system coordinates (Lmax, 0, 0), (Lmin, 0, 0), and (Lr_γ, Cr_γ, Hin) (i.e., a surface obtained by cutting out the YUV space by the hue Hin). On the other hand, the corrected L component value, the corrected C component value, and the corrected H component value exist on a surface formed by LCH-system coordinates (Lmax, 0, 0), (Lmin, 0, 0), and (Lt_γ, Ct_γ, Hout) (i.e., a surface obtained by cutting out the YUV space by the hue Hout).

Lout=(Lin−La)·(Ld−Lc)/(Lb−La)+Lc

La=Cin/Cr_γ×(Lr_{—}γ−Lmin)

Lb=Cin/Cr_γ×(Lr_{—}γ−Lmax)+Lmax

Lc=Cout/Ct_γ×(Lt_{—}γ−Lmin)

Ld=Cout/Ct_γ×(Lt_{—}γ−Lmax)+Lmax

Lr_{—}γ=Lr_β+(Lr_{—}α−Lr_β)×θ2/(θ1+θ2)

Lt_{—}γ=Lt_β+(Lt_{—}α−Lt_β)×θ4/(θ3+θ4) [Equation 4]

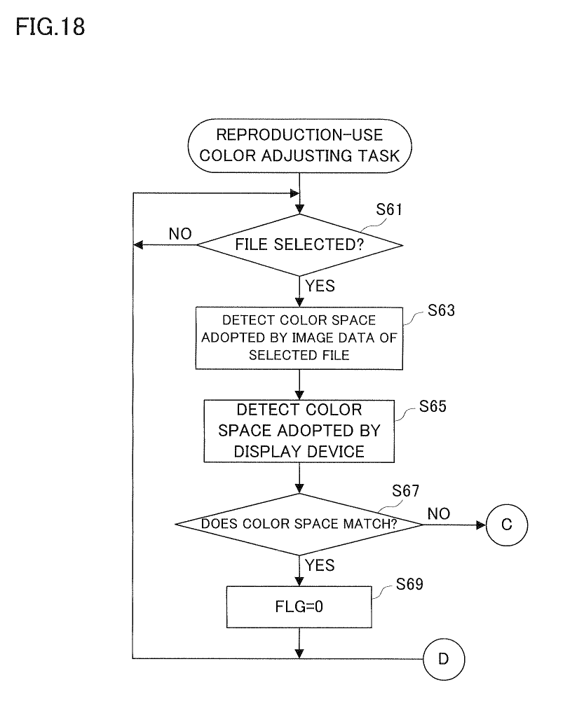

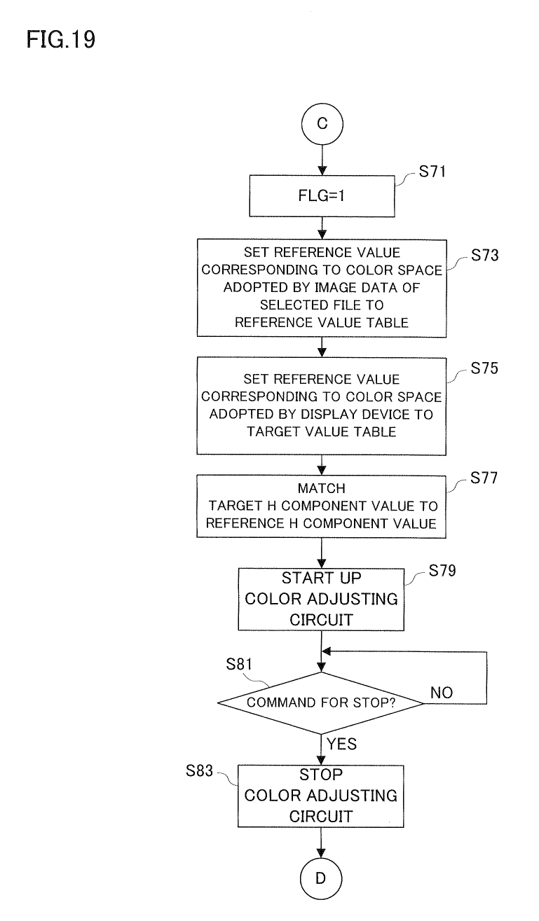

When controlling the magnitudes of the reference values set to the reference value table TBLref and the target values set to the target value table TBLtrgt, together with start-up/stop of the color adjusting circuit 40, the CPU 30 executes a reproduction-use color adjusting task shown in FIG. 18 and FIG. 19 under the reproduction mode. It is noted that a control program corresponding to this task also is stored in the flash memory 48.

Firstly, in a step S61, it is determined whether or not the still image file or the moving image file is selected. When a determined result is updated from NO to YES, the process advances to a step S63 so as to detect the color space adopted by the image data contained in the selected file. Upon this detection, the color space information described in a header of the selected file is referred to.

In a step S65, the color space adopted by the display device is detected. If the display device is the LCD monitor 38, then the sRGB color space is fixedly detected. If the display device is the external display, the color space is detected by referring to the color space information notified from the external display or referring to the color space information inputted by a manual operation of an operator.

In a step S67, it is determined whether or not the color space detected in the step S65 matches the color space detected in the step S63. When a determined result is YES, the process advances to a step S69 so as to set the flag FLG to “0” in order to declare that the color spaces match. Upon completion of the process in the step S59, the process returns to the step S61.

When the determined result in the step S67 is NO, the process advances to a step S71 so as to set the flag FLG to “1” in order to declare that the color spaces differ. In a step S73, the numerical values corresponding to the color space detected in the step S63 is set to the reference value table TBLref. In a step S75, the numerical values corresponding to the color space detected in the step S65 is set to the target value table TBLtrgt.

In a step S77, the magnitudes of the target H component values set to the target value table TBLtrgt are made to match the magnitudes of the reference H component values set to the reference value table TBLref. Upon completion of the process in the step S77, the color adjusting circuit 40 is started up in a step S79. In a step S81, it is determined whether or not a command for stopping the color adjusting circuit 40 is issued. When a determined result is updated from NO to YES, the color adjusting circuit 40 is stopped in a step S83. Thereafter, the process returns to the step S61. It is noted that the command for stopping the color adjusting circuit 40 is issued at a time point at which the reproduction of the still image or the moving image is completed.

As can be seen from the above-described explanation, the target value table TBLtrgt holds the plurality of target values respectively corresponding to the plurality of representative colors. The L adjusting circuit 82, the C adjusting circuit 84, and the H adjusting circuit 86 refer to the plurality of target values held on the target value table TBLtrgt so as to adjust the lightness, the color saturation, and the hue of the image data to be reproduced. In a case where the internal LCD monitor 38 is selected as the display device, the LCD driver 36 drives the LCD monitor 38 based on the image data having the adjusted lightness, color saturation, and hue. In a case where the external display is selected as the display device, the image output circuit 46 outputs the image data having the adjusted lightness, color saturation, and hue, toward the external display. The CPU 30 detects the color space adopted by the display device in association with the above-described color adjusting process (S65), and sets the magnitudes of the plurality of target values held on the target value table TBLtrgt to the magnitudes corresponding to the detected color space (S75).

Thus, the color space adopted by the display device is detected by the CPU 30, and the magnitudes of the plurality of target values are set to the magnitudes corresponding to the detected color space. This enables operability improvement achieved when the setting is changed so as to adapt to the color space adopted by the display device.

It is assumed that in this embodiment as the external display, any one of “sRGB”, “adobe RGB”, and “xvYCC” is adopted. However, as the external display, two or three of “sRGB”, “adobe RGB”, and “xvYCC” may be adopted, and any one of the color spaces may be selected by a manual setting. In this case, when the color space adopted by the reproduced image data and the color space selected by the external display differ, a process for outputting a guidance for urging an operation for changing the color space selected by the external display to the color space adopted by the reproduced image data may be preferably added.

Moreover, in this embodiment, the selector 76 which selects the zoom circuit 68 corresponding to the through-image process while selecting the zoom circuit 74 corresponding to the still-image recording process or the moving-image recording process is arranged. However, if a bus capable of simultaneously transferring two-system image data is adopted, then the selector 76 becomes unnecessary.

Furthermore, in this embodiment, the crystal liquid-type monitor is adopted as the display device; however, instead thereof; a monitor in an organic EL type or a plasma type may be optionally adopted. Moreover, in this embodiment, the six representative colors of Magenta (Mg), Red (R), Yellow (Ye), Green (G), Cyan (Cy), and Blue (B) are assumed; however, the present invention can also be applied to a case where a representative color other than the above colors is used. Furthermore, in this embodiment, a digital camera is assumed; however, the present invention can be applied not only to the digital camera but also to an image processing apparatus such as a printer, a video recorder, and a video player.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A color adjusting apparatus, comprising:
a first holder which holds a plurality of first color adjusting values respectively corresponding to a plurality of representative colors;
an adjuster which adjusts a color of an original image by referring to the plurality of first color adjusting values held by said first holder;
an outputter which outputs an image having the color adjusted by said adjuster, toward a display device;
a first detector which detects a color space adopted by the display device in association with the adjusting process of said adjuster; and
a first setter which sets magnitudes of the plurality of first color adjusting values held by said first holder, to magnitudes corresponding to the color space detected by said first detector.

2. A color adjusting apparatus according to claim 1, further comprising a second holder which holds a plurality of second color adjusting values respectively corresponding to the plurality of representative colors, wherein said adjuster executes the adjusting process by further referring to the plurality of second color adjusting values held by said second holder.

3. A color adjusting apparatus according to claim 2, further comprising:
a second detector which detects a color space adopted by the original image in association with the adjusting process of said adjuster; and
a second setter which sets magnitudes of the plurality of second color adjusting values held by said second holder, to magnitudes corresponding to the color space detected by said second detector.

4. A color adjusting apparatus according to claim 1, further comprising:
an imager which captures a scene;
a color processor which performs a color process corresponding to a designated color space on the image outputted from said imager; and
a recorder which records the image processed by said color processor, wherein the original image is equivalent to any one of one or at least two images recorded by said recorder.

5. A color adjusting apparatus according to claim 1, further comprising a limiter which limits a hue adjustment by said adjuster.

6. A color adjusting apparatus according to claim 1, wherein the color space adopted by each of the original image and the display device corresponds to any one of sRGB, adobe RGB, and xvYCC.
